(19) United States
(12) Patent Application Publication
(10) Pub. No.: US 2005/0102362 A1
(43) Pub. Date: May 12, 2005

(54) Instant messaging messages and commands for status and control

(75) Inventors: Stephen G. Price, Longmont, CO (US); Suzanne L. Price, Longmont, CO (US)

Correspondence Address: DRIGGS, LUCAS, BRUBAKER & HOGG CO., L.P.A., 35800 CHARDON ROAD, WILLOUGBY HILLS, OH, 44094, US

(73) Assignee: International Business Machines Corporation, Armonk, NY (US)

(21) Appl. No.: 10/703,693

(22) Filed: Nov. 7, 2003

(51) Int. Cl. G06F 15/16; G06F 15/177

(52) U.S. Cl. 709/206; 709/222; 358/1.15

(57) ABSTRACT

A method and system for communicating with computer system peripheral devices, wherein Instant Messaging software is embedded within a peripheral device and the peripheral device uses the embedded software to communicate with a computer system responsive to an event. In one embodiment the peripheral device uses the embedded software to send out Instant Messaging messages responsive to a status of the peripheral device or an event. In another embodiment the peripheral device uses the embedded software to receive and process at least one Instant Messaging message from a user, application program or other device, and to responsively take action to the at least one message. According to the present invention a device may use the embedded software to create the Instant Messaging message responsive to a characteristic of the output job or a status of the device.

### FIELD OF THE INVENTION

This invention relates in general to communication by a computer system with peripheral devices through Instant Messaging software applications.

### BACKGROUND OF THE INVENTION

Common computer system peripheral devices include printers, plotters, scanners, fax machines and multi-function devices (MFD's) that combine some or all of these capabilities and other document-handling services. It is common for computer systems peripheral devices to be shared by several users. Problems arise wherein some users are not located close enough to see a peripheral device and observe the status of their output jobs. In other situations, such as large production print operations, peripheral devices may have a person dedicated to overseeing their operation, but the size of the operation may prevent that operator from being able to see the status of the equipment. Thus, there is a need for peripheral devices to report status remotely.

Moreover, operator panels are typically built into peripheral devices to display status and provide a control interface. When such a device is located remote from a user or overseer there is also a need to provide some remote means of controlling and configuring peripheral devices. More recently, means have been provided that allow for answering status queries and issuing commands remotely.

Prior art methods for addressing remote monitoring and/or control of peripheral devices include the following:

Dedicated host control software. Examples of this type of software are the various versions of IBM Corporation's Print Services Facility™ software. Such software controls the printing and reports status promptly, but is not suitable for casual end-users, and may not be able to be shared easily among a group of users. Moreover, such software controls the printing and reports status promptly, but is not suitable for general printer configuration and control, and provides a limited ability to submit and report the answers to queries. Additionally, this software is not suitable for client workstation use. And it is generally not convenient for administration of the remote device, because it is optimized for print job management.

Remote operator panel software for client workstations, with special support in the devices to communicate with it. This solution has the disadvantage of requiring the software to be installed on the client workstation, and takes up computing resources on that computer, occupies screen real estate, and the usability is limited by the usability of the physical operator panel being modeled.

Simple Network Management Protocol (SNMP) based monitoring software. SNMP support is now common in such peripheral devices, and allows standards-based software to communicate with it, even software from different vendors. This provides a more powerful and easier to use interface than the dedicated operator panel software, but suffers from the same disadvantages of requiring a special application and dedicated resources on the client computer.

Web-based status reporting in the device. Here a device hosts a web server that provides status and allows for remote configuration of the printer. This requires no client software other that the now nearly-universal web browser. But it does not provide asynchronous status updates unless the user keeps a browser window open to watch the printer, and some products (e.g. IBM Corporation's Infoprint® 21 printer and Xerox Corporation's Document Centre® multi-function device) do not provide automatic status updates: the user must click the web browser reload button to see the latest status. Moreover it may be found inconvenient by some users, mainly because the user sometimes has to “drill down” through several levels to get to the web page supporting the desired function.

E-mail notification from the printer. This requires only the now nearly-universal e-mail client, which can provide asynchronous notification of new e-mails. The disadvantage is that the user must access the e mail program and (unless the status message is brief enough to be included in the subject line) open the e-mail to read the status information. The user must also discard the message after reading it. Moreover, the only control service known to date is submission of print jobs. A command and control interface could theoretically be implemented using e-mail, but it would be undesirably cumbersome in requiring a large number of steps. For example, the following steps would be required: open an e-mail creation program, select a destination, compose an e-mail, click send, wait for an e-mail program to make the reply available, open a reply to read the response, and discard the e-mail.

What is needed is a method and system that does not need dedicated client software (in common with web and e-mail notification); that is a more convenient way to receive and view short status messages compared to e-mail; and that does not require dedicated screen real estate like a web browser.

### SUMMARY OF THE INVENTION

A method and system for communicating with computer system peripheral devices, wherein Instant Messaging software is embedded within a peripheral device. The peripheral device uses the embedded software to communicate with a computer system responsive to an event. In one embodiment the peripheral device uses the embedded software to send out Instant Messaging messages responsive to a status of the peripheral device or an event. In another embodiment the peripheral device uses the embedded software to receive and process at least one Instant Messaging message from a user, application program or other device, and to responsively take action to the at least one message. According to the present invention a device may use the embedded software to create the Instant Messaging message responsive to a characteristic of the output job or a status of the device.

### BRIEF DESCRIPTION OF THE DRAWINGS

FIG. 1 is a high level block diagram of the main hardware components of an electronic control unit of a peripheral device according to the present invention. FIG. 1 also illustrates an embodiment of the invention tangibly embodied in a computer program residing on a computer-readable medium or carrier.

FIG. 2 illustrates the device of FIG. 1 communicating with a user computer and a device with embedded Instant Messaging software according to the present invention

FIG. 3 is a flowchart that shows the processing of an Instant Messaging command sent to a peripheral device according to the present invention.

FIG. 4 is a flowchart showing steps involved in sending Instant Messaging messages responsive to certain events or status changes in a device containing embedded Instant Messaging software according to the present invention.

### DESCRIPTION OF THE PREFERRED EMBODIMENTS

The present invention provides for a computer system peripheral device, such as a printer, to have embedded software to act as an “Instant Messaging” client using one or more of the common Instant Messaging protocols, such as Internet Relay Chat (IRC), America On Line® Instant Messenger™, or Lotus Sametime®. The peripheral device sends brief status reports to an appropriate user or users with brief Instant Messaging messages. In preferred embodiments the client programs provide audible alarms and pop-up windows when the new messages arrive. No large software resource commitments are required on the client workstations except for the Instant Messaging program itself, which is relatively small. And where a popular common program is chosen, it may already be resident on the client workstation or computer system. Though not all Instant Messaging programs may be able to interact with each other, standards are emerging that will establish wide interoperability.

According to the present invention, Instant Messaging programs provide a useful command and control interface for status queries, configuration queries, control commands, and print job submission. Even for remote status, configuration, and control services where the invention may not be ideal, it would be a useful adjunct to other prior art systems and methods.

It is intended that the peripheral device, such as a printer, multi-function device or other device, has customized Instant Messaging client software embedded in it. The customized software would be based on common Instant Messaging programs that operate as Instant Messaging “bots”, where automated response services are implemented. Instant Messaging “bot” applications are common for operations such as delivering stock quotes or dictionary definitions.

Instant Messaging software typically works by allowing client computers (like a stand-alone office PC) to talk to other people's client computers through an Instant Messaging server, which among other things, routes messages to their proper destination. When a person starts up an Instant Messaging program on their computer, they are putting themselves in contact with the IM Server, and through the IM server they communicate with other IM client computers or devices. According to the present invention, attaching a printer with embedded IM software to a network places the printer in communication with an IM Server and potentially with an active IM client also connected to the network. Thus the embedded software effectuates communication with the appropriate IM client through the IM server.

Embedded software can be configured with Instant Messaging user identification codes (“userids”) or addresses of specified parties to notify for various situations. When a condition arises (for example, out of paper, out of supplies, hardware problems, etc.) then an appropriate Instant Messaging message is sent to an appropriate party. Similarly, job status messages (e.g., document scanned and held or delivered, job printed, print job suspended due to paper jam, fax delivered) messages can also be sent to the user's workstation via Instant Messaging. In some embodiments, if that party is not accepting messages, then an e-mail could be sent instead.

Alternatively, rather than configuring the embedded software with Instant Messaging user userids or addresses, jobs sent to the device may include one or more Instant Messaging userids/addresses for job status messages. As above, e-mail could be sent if the Instant Messaging client is not available.

The use of paging technology is well known in the art. Printers such as the IBM Corporation Infoprint® 21 send e-mails that can be relayed to pagers; and IBM Corporation's NetView® and Network Printer Toolbox are network system monitoring applications that send pager messages. What is new under the present invention is to provide an Instant Messaging interface for pager dispatch by a network Instant Messaging “bot”, a more convenient way to send pager messages than the methods used today.

According to the present invention Instant Messaging support in the device can coexist with and complement the other status features in the device, such as SNMP, web server, e-mail, etc. For existing devices that have e-mail notification software in them, the Instant Messaging software would be most appropriately implemented as an extension of that software. For both e-mail and Instant Messaging, short messages must be created based on events that happen in the device (job completion, out of paper, out of toner, paper jam, etc) and must be directed to one (or more) specific users (job completion would be sent to the submitter of the job, out-of-supply conditions would be reported to the designated key operator, mechanical failures would be reported to a designated service dispatcher or service provider).

For devices without e-mail notification, software specific aspects of each particular device design will determine the optimal application of the present invention. What is important is to provide a means of setting Instant Messaging userids or addresses for one or more designated people to handle device problems; associating Instant Messaging userids or addresses for job status notifications with the corresponding jobs; and efficiently detecting events in the device that need to be reported.

In some embodiments of the present invention Instant Messaging can be implemented interactively with the device. Thus a device can support certain commands that may be received over Instant Messaging from a user and respond to those commands. For example, query commands may include read-only requests for printer device status (ready, printing, out of toner, etc), job status (the list of pending jobs, the list of spooled jobs, the list of send and save jobs, etc), printer configuration (number of paper trays, size of paper in trays, features installed (duplexer, hard drive, etc), microcode levels, etc), configuration settings (network addresses, default fonts, etc) and other useful information, such as is already provided by web pages, SNMP, and the operator panel.

Instant Messaging commands can also be implemented to set some or all of the settable configuration items in the printer (“configuration commands”): thus a user may set the default input and output trays, default font, network parameters, or even the Instant Messaging address for error messages such as those described above.

A device according to the present invention may have facilities for holding a queue of pending jobs. Examples are a simple first-in first-out spool queue, or a sophisticated database of stored jobs (e.g., the send and save facility in the IBM Corporation Infoprint® 2105 device). Instant Messaging commands could thus function as queue commands: wherein the device responsively lists the jobs queued and their attributes (size, time of receipt, name of job, etc.). Instant Messaging queue commands can also allow management of jobs, such as holding, releasing, deleting, and reordering them.

Another application of the present invention is in “Trace and Diagnostic facilities.” Though unseen by users and administrators of prior art peripheral devices, it is common for internal debug facilities to provide such functions, such as for example trace buffers and diagnostic routines. When problems are encountered in the devices, such facilities are used to help determine the nature of the problem. According to the present invention Instant Messaging commands can be implemented to turn on and off tracing, either in whole or in part; see the results of the trace; and execute diagnostic commands and retrieve the results. An Instant Messaging command could also be provided to have the device send the contents of a trace to the person doing the debugging by whatever methods the device has for exporting data, which might include sending e-mail or accessing a network storage device as provided by a Network File System (NFS).

The present invention is of particular value during the development cycle of a new product, where it would make common debugging easier. The invention also simplifies debugging in customer support situations after the product has shipped.

Printing functions can also be incorporated. For example, a feature that prints out the Instant Messaging messages received may be incorporated. Also, “pull print requests” can be implemented through Instant Messaging. For example, a “PRINT URL http://www.irs.gov/forms/2001/1040.pdf” Instant Messaging command sent by a user to a printer device configured according to the present invention will cause the printer to perform the operation known informally as “pull printing”, in which the printer retrieves a document over the Internet or intranet and prints it.

The present invention may further support a two way Instant Messaging dialog. When submitting a print job, a printer could “ask” query questions, for example: “How many copies?”, “What type paper?”, “Do you want it stapled?” etc. Such job modifiers could also be included on an initial command, wherein a dialog would only be started when modifiers are not provided, or when a user requests a dialog, for example either by a special command or by a modifier on the print command. Configuration commands may be incorporated in such a dialog feature. For example, the command CONFIGURE TCPIP might be followed by a Instant Messaging dialog including “What IP Address?”, “What Subnet Mask?”, “What Gateway Address?”, etc.

The present invention can also print files using an Instant Messaging protocol that supports file transfer. This would work like a “push print” command. AOL Corporation Instant Messenger™ supports such a file transfer capability; IBM Lotus Sametime® does not.

Protection against unauthorized access or commands may be incorporated in the present invention, for example to limit access to a configuration setting function and thereby prevent unauthorized or uninformed tampering with device settings. Password protection can be incorporated and required for a given command. Commands may also use encryption protection; for example, an embodiment of the present invention may use Sametime® Instant Messaging software, which supports encryption. In other embodiments an embedded device may contain a list of userids authorized to submit commands. Some Instant Messaging software uses secure central servers and authenticates all users; an embedded device according to the present invention could piggyback on that existing authentication function. Furthermore, an embedded device may ship from a manufacturer to an end-user with no users listed as authorized; some non-Instant Messaging method (e.g., web pages, operator panel, SNMP) may then be used to authorize specific users to issue Instant Messaging commands.

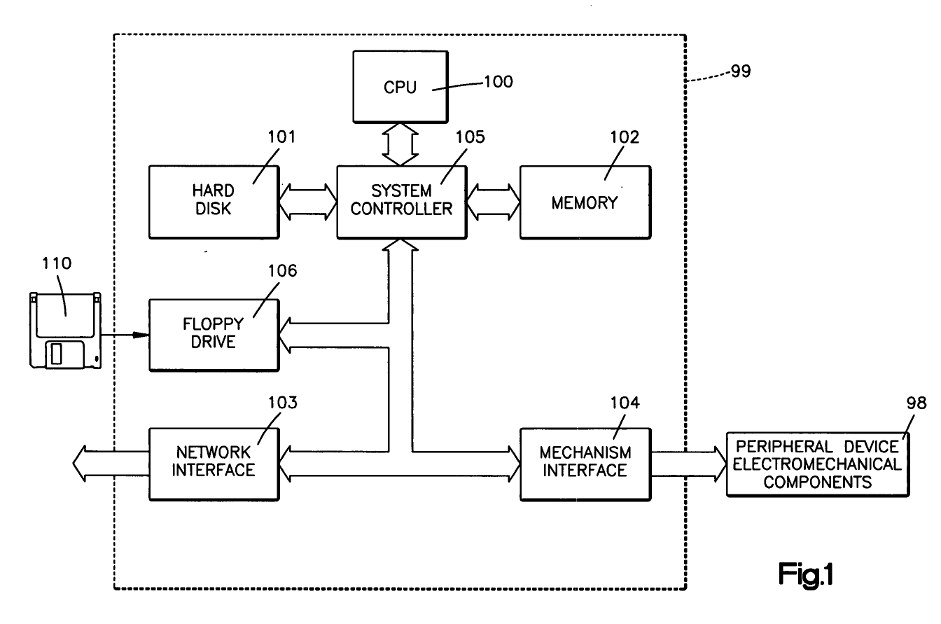

FIG. 1 is a high level block diagram of a typical computer peripheral device controller 99. Those skilled in the art will observe that it is typical of general purpose embedded computer architecture. A CPU 100 is coupled to a System Controller 105 which provides a signaling interface between Memory 102 (typically DRAM), Hard Disk 101, Floppy Drive 106, Network Interface 103 and Mechanism Interface 104. The Mechanism interface 104 consists of custom hardware and software which is uniquely designed to exchange data with and control a specific peripheral device such as a printer or a multifunction device 98.

Program files and data are stored on one or more computer-readable mediums or carriers, such as Hard Disk 101, or Floppy Disc 110 accessed through Floppy Drive 106. The files and data are read into Memory 102 for execution by CPU 100. The present invention may be tangibly embodied in a computer program residing on the Hard Disk 101, Floppy Disc 110, other type of fixed and/or removable data storage device, or some other type of data storage or data communications device. The computer program comprises instructions which, when read and executed by the peripheral device controller 99 causes the device to perform the steps necessary to execute the steps or elements of the present invention.

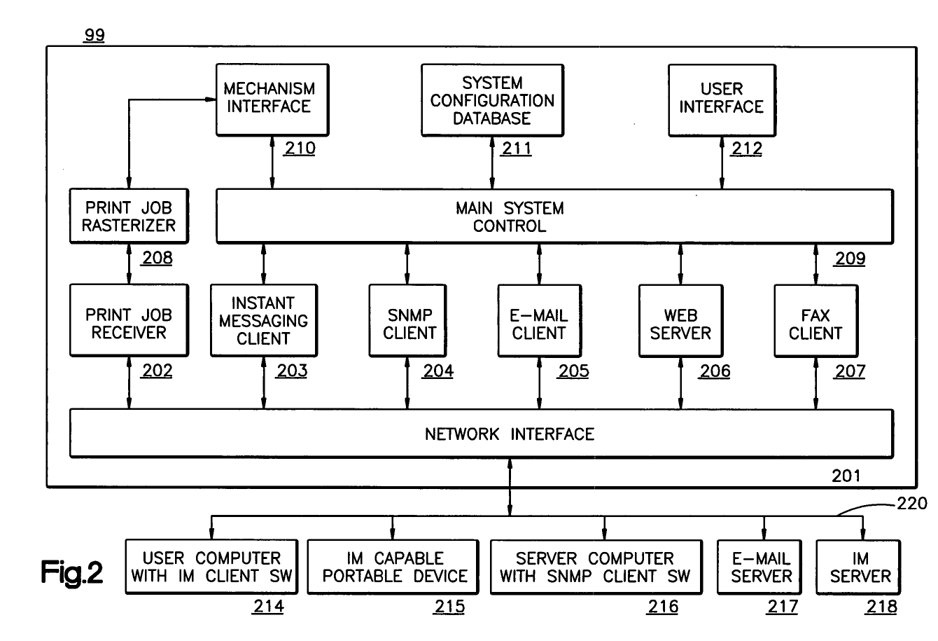

FIG. 2 illustrates the software architecture of the computer peripheral device 99, in order to illustrate communication with a user computer 214 and a device with embedded Instant Messaging software 215 according to the present invention. A Network interface 201 communicates with a network 220 and passes data between the network 220 and various network applications in the device 20-0. A Print job receiver 202 takes jobs from the network interface 201 and passes them to a print job rasterizer 208.

When a reportable system event such as print job completion, print job error or scan error occurs, the event is reported to The Instant Messaging client 203, the SNMP client 204, the e-mail client 205, and the web server 206. Each client checks the event message flags to determine if the event is to be reported by that client. If yes for a particular client, it queries Main System Control 209 for specific destination information. Main System Control 209 pulls the destination information from the System Configuration Database and passes it to the requesting client.

In the case of the Instant Messaging client 209, an instant message is passed out through the Network Interface 201 via the IM server 218, preferably to either a user computer 214 running an IM client or an IM capable portable device 215. The Instant Messaging client is also capable of receiving instant messages from a user computer 214 or IM capable portable device 215, via the IM server 218 through Network Interface 201. These messages are passed to Main System Control 209 for processing as appropriate according to the message content.

If the SNMP client 204 needs to pass the event message data, it is formatted into SNMP data packets and passed out through the Network Interface 201 to a Server 216. The SNMP Client 204 is also capable of receiving SNMP packets, which it passes on to the Main System Control 209 for handling.

If the e-mail client 205 needs to pass the event message data, it composes an e-mail message and sends it out through the Network Interface 201 to an e-mail server 217. The e-mail client 205 is also capable of receiving e-mail messages, which it passes on to the Main System Control 209 for handling.

A Web server 206 receives web page requests from the network interface 201 and responds by sending the requested web pages to the network interface 201.

A Fax client 207 receives network-routed fax jobs from the network interface 201 and sends them to the main system control 209 for processing. Fax client 207 also receives scanned-in data from the main system control component 209 and sends the data as a network-routed fax job to the network interface 201.

A System configuration database 211 stores the values of parameters that are used to control aspects of operation of the system, including networking parameters and print job processing parameters as well as notification addressing parameters such as instant messaging ids and e-mail addresses.

A Print job rasterizer 207 receives print jobs from the print job receiver 202, turns them into images of the pages to be printed, and sends them to a mechanism interface 210 which causes them to be printed. The Print job rasterizer 208 also communicates with main system control component 209 to get control information on how jobs should be printed, including system settings stored in system configuration database 211.

The Mechanism interface 210 receives images of pages of print jobs from print job rasterizer 208 (for print jobs) and prints them. It also receives images of pages of fax jobs from fax client 207 by way of main system control component 209 and prints them. It also operates a scanner and receives images of pages of scan jobs. It sends these images to main system control component 209, which passes them to fax client 207, which transforms them into a fax job and passes them to network interface 201, which sends them over the network.

User interface 212 shows the status of the device as directed by main system control component 209. It also provides an interface for control requests (such as “start”, “stop”, “cancel job”) that it sends to main system control component 209. In addition, it displays system parameter values stored in system configuration database 211 via main system control component 209, and it provides a means for an operator to change those values.

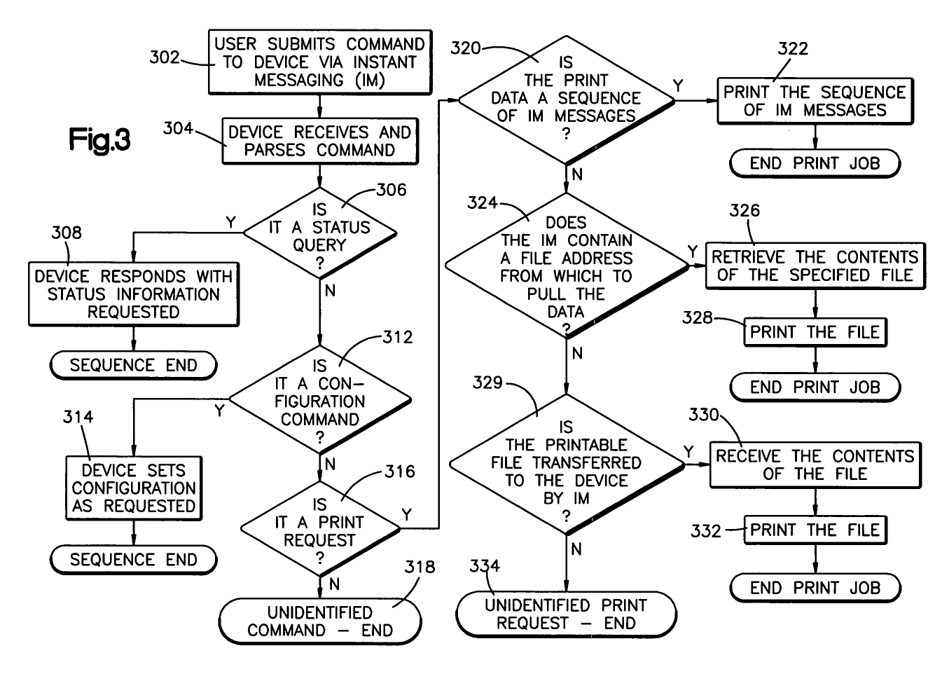

FIG. 3 is a flowchart that shows the processing of an Instant Messaging command sent to a peripheral device, more specifically a printer, according to the present invention. In step 302 a user submits a command to a device using Instant Messaging software. In step 304 the message is received and parsed. It is then determined at 306 if the command is a status query. If so, the device sends back the answer in an Instant Messaging message in step 308. If not, it is determined if the command is a configuration command at step 312.

If the command is a configuration command, the device sets configuration values as requested at step 314. If the message was not a query or a configuration command, it is determined if the command is a print request at step 316. If the command is not a print request, processing ends at step 318. If the command is determined to be a print request, it is further determined at step 320 if the request is a request to print a sequence of Instant Messaging messages. If so, the messages are printed at step 322. If the command is determined not to be a request to print a sequence of Instant Messaging messages, it is determined at step 324 if the command contains the address of a place from which to pull the data for the print job. If so, the print job is retrieved from the remote location at step 326 and printed at step 328. If the command is determined not to contain the address of a place from which to pull the data for a print job, then it is further determined if the command is a request to print a printable file to be transferred by Instant Messaging protocol at step 329. If so, the print job is received at step 330 and printed at step 332. If the command is determined not be a command to print a file being transferred by Instant Messaging protocol, the process instead ends at step 334.

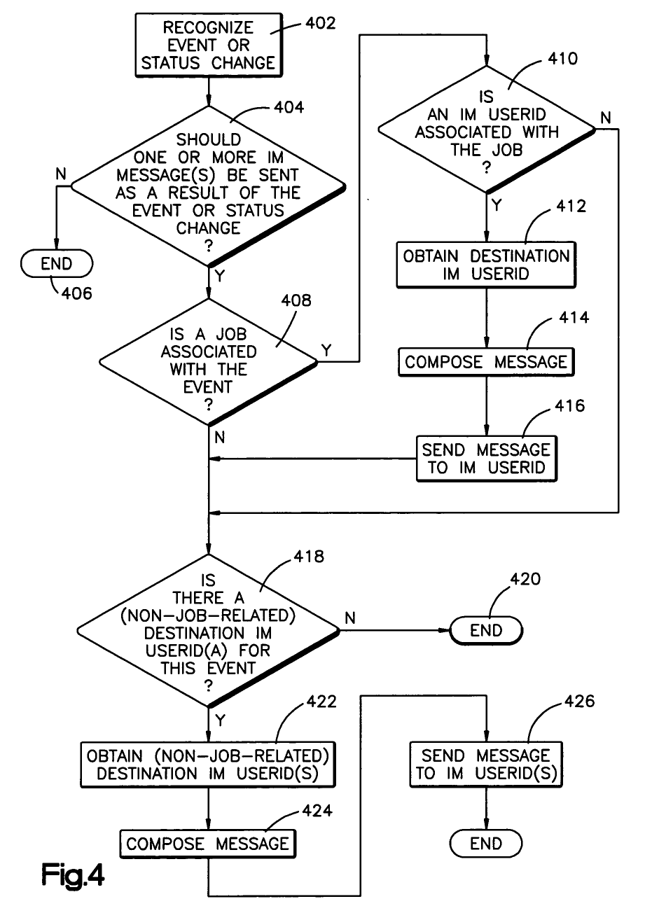

FIG. 4 is a flowchart showing the main steps involved in sending Instant Messaging messages in response to certain events or status changes in a device containing embedded Instant Messaging software. Processing starts when a significant event or status change is recognized at step 402. First a decision is made whether or not an Instant Messaging message should be sent in response to the event or status change at step 404. If not, processing ends at step 406. If so, instead it is determined whether the event or status change is associated with a job in the device at step 408. If so, it is determined if an Instant Messaging userid is associated with the job at step 410: if so, the userid is obtained (step 412), a message is composed (step 414), and the message is sent to the userid by Instant Messaging (step 416). However, if the event or status change was not associated with a job as determined at step 408, or it was but no userid was associated with the job as determined at step 410, then it is determined whether an Instant Messaging userid is associated with the event or status change at step 418. If not, processing ends at step 420. If so, the userid is obtained (step 422), a message is composed (step 424), and the message is sent by Instant Messaging (step 426).

The foregoing description of the exemplary embodiment of the invention has been presented for the purposes of illustration and description. It is not intended to be exhaustive or to limit the invention to the precise forms disclosed. Many modifications and variations are possible in light of the above teaching. It is intended that the scope of the invention be limited not with this detailed description, but rather by the claims appended hereto.

1. A method for a peripheral device to communicate with a computer system comprising the steps of:
providing a peripheral device having Instant Messaging software embedded within;
placing the peripheral device in communication with a computer system comprising an instant messaging server; and
the peripheral device using the embedded software to communicate to a client through the instant messaging server responsive to an event.

2. The method of claim 1 wherein the step of the peripheral device using the embedded software to communicate with the client comprises the steps of the peripheral device using the embedded software to create a message responsive to the event and sending out the message.

3. The method of claim 2 further comprising the steps of:
configuring the peripheral device to define at least one Instant Messaging userid; and
wherein the message is an instant message, and the step of the peripheral device sending out the message comprises sending the instant message to a client associated with the at least one Instant Messaging userid.

4. The method of claim 2 further comprising the step of submitting a job to the peripheral device comprising at least one Instant Messaging userid associated with the job; and
wherein the message is an instant message, and the step of the peripheral device sending out the message comprises sending the instant message to a client associated with the at least one Instant Messaging userid.

5. The method of claim 2 further comprising the steps of:
configuring the peripheral device to define a client associated with at least one Instant Messaging userid;
the device detecting that the client is not able to receive an instant message; and
the device responsively using an alternative method to deliver the message.

6. The method of claim 5 where the alternative method is e-mail.

7. The method of claim 5 where the message is an instant message, and the alternative method is sending the instant message to one or more alternate clients.

8. The method of claim 3 further comprising the step of maintaining the at least one Instant Messaging userid in the peripheral device by a secure means.

9. The method of claim 8 wherein the secure means is a password-protected area of a configuration data structure.

10. The method of claim 2 wherein the step of the peripheral device using the embedded software to communicate with the computer system further comprises the steps of:
the peripheral device receiving at least one Instant Messaging message;
the peripheral device processing the at least one message with the embedded software; and
the peripheral device taking action responsive to the at least one message.

11. The method of claim 10 wherein the at least one message is a query command, and the action taken by the peripheral device is responsively replying with requested information.

12. The method of claim 10 wherein the action taken by the peripheral device is responsively changing peripheral device configuration settings.

13. The method of claim 10 wherein the action taken by the peripheral device is responsively rebooting the peripheral device.

14. The method of claim 10 wherein the action taken by the peripheral device is responsively managing work being processed in the device by holding, deleting, reordering or releasing at least one print job.

15. The method of claim 11 wherein the action taken by the peripheral device is responsively printing a print job.

16. The method of claim 15 where the print job is a sequence of Instant Messaging messages.

17. The method of claim 15 where the print job is a printable file residing on a server and the message identifies the printable file, further comprising the step of the peripheral device retrieving the file from the server.

18. The method of claim 15 where the print job is a printable file, further comprising the step of transferring the print job to the peripheral device via an Instant Messaging communication service.

19. The method of claim 10 wherein the action taken by the peripheral device is responsively changing a trace status in the peripheral device.

20. The method of claim 10 wherein the action taken by the peripheral device is responsively performing at least one diagnostic function and returning diagnostic function results.

21. The method of claim 10 further comprising the step of the peripheral device requiring a sender of the Instant Messaging message to supply a password.

22. A computer system peripheral device comprising Instant Messaging software embedded within the device, wherein the peripheral device is configured to use the Instant Messaging software to communicate with a client responsive to an event, wherein the communication is facilitated by an instant messaging server.

23. The peripheral device of claim 22 wherein the peripheral device is configured to use the embedded software to create a message and send out the message to the client responsive to the event.

24. The peripheral device of claim 23 further configured to define at least one Instant Messaging userid associated with the client and send out the message responsive to said association.

25. The peripheral device of claim 23 further configured to receive a job comprising at least one Instant Messaging userid associated with the client and send the message to the client responsive to the association.

26. The peripheral device of claim 23 further configured to define at least one Instant Messaging userid associated with the client;
detect that the client is not able to receive an instant message; and
send out the message to the client using an alternative method.

27. The peripheral device of claim 28 where the alternative method is e-mail.

28. The peripheral device of claim 26 where the alternative method is sending an instant message to one or more alternate instant messaging users in communication with the instant messaging server.

29. The peripheral device of claim 24 further comprising a secure means containing the at least one Instant Messaging userid.

30. The peripheral device of claim 29 wherein the secure means is a password-protected area of a configuration data structure.

31. The peripheral device of claim 22 further configured to receive at least one Instant Messaging message from a sender, process the at least one Instant Messaging message with the embedded software and take action responsive to the at least one Instant Messaging message.

32. The peripheral device of claim 31 wherein the action taken by the peripheral device is responsively replying with requested information.

33. The peripheral device of claim 31 wherein the action taken by the peripheral device is responsively changing peripheral device configuration settings.

34. The peripheral device of claim 31 wherein the action taken by the peripheral device is responsively rebooting the peripheral device.

35. The peripheral device of claim 31 wherein the action taken by the peripheral device is responsively managing work being processed in the device by holding, deleting, reordering or releasing at least one print job.

36. The peripheral device of claim 31 wherein the action taken by the peripheral device is responsively printing a print job.

37. The peripheral device of claim 36 where the print job is a sequence of Instant Messaging messages.

38. The peripheral device of claim 36 where the print job is a printable file residing on a server and the message identifies the printable file, wherein the peripheral device is further configured to retrieve the file from the server.

39. The peripheral device of claim 36 where the print job is a printable file transferred to the peripheral device via an Instant Messaging communication service.

40. The peripheral device of claim 31 wherein the action taken by the peripheral device is responsively changing a trace status in the peripheral device.

41. The peripheral device of claim 31 wherein the action taken by the peripheral device is responsively performing diagnostic functions and returning diagnostic function results to the sender.

42. The peripheral device of claim 31 further configured to require the sender to supply a password.

43. An article of manufacture comprising a computer usable medium having a computer readable program comprising Instant Messaging software embodied in said medium, wherein the computer readable program, when executed on a device having a processor and in communication with a computer network system, causes the device to communicate with a client responsive to an event, said communication enabled through the use of a instant messaging server present on the network.

44. The article of manufacture of claim 43 wherein the computer readable program, when executed on the device, causes the device to create a message and to send out the message to the client responsive to the event.

45. The article of manufacture of claim 43 wherein the computer readable program, when executed on the device, cause the device to receive and process at least one Instant Messaging message from a sender, and to take action responsive to the at least one Instant Messaging message.
